(19) United States
(12) Patent Application Publication
(10) Pub. No.: US 2007/0104123 A1
(43) Pub. Date: May 10, 2007

(54) METHOD TO PROVIDE CENTRALLY COORDINATED CONTENTION-FREE CHANNEL ACCESS WITHIN A WIRELESS MESH NETWORK

(75) Inventors: John L. Tomici, Southold, NY (US); Catherine M. Livet, Montreal, QC (CA); Shamim Akbar Rahman, Montreal, QC (CA); Juan Carlos Zuniga, Montreal, QC (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/557,850

(22) Filed: Nov. 8, 2006

Related U.S. Application Data
(60) Provisional application No. 60/734,741, filed on Nov. 8, 2005.

(51) Int. Cl. H04B 7/00; H04L 12/26

(52) U.S. Cl. 370/310; 370/229

(57) ABSTRACT

In a wireless local area network (WLAN) mesh network of clusters, each cluster having a master node with a plurality of associated slave nodes, a method an apparatus for coordinating channel access between the clusters. A structure of clusters is established as a hierarchal mastership, wherein a high level master node serves a plurality of subservient master nodes. The hierarchal mastership is controlled by the high level master node using an HCF controlled channel access (HCCA) mechanism. Alternatively, the structure of clusters is configured as a peer-to-peer mastership that controls channel access by a distributed mechanism, such as EDCA.

### CROSS REFERENCE TO RELATED APPLICATION

This application claims priority from U.S. Provisional Patent Application No. 60/734,741, filed Nov. 8, 2005, which is incorporated by reference as if fully set forth.

### FIELD OF INVENTION

This invention relates to wireless mesh networks, particularly to centrally coordinated contention-free channel access among nodes in such networks.

### BACKGROUND

Hereafter, a station (STA) includes but is not limited to a node, mesh point, wireless transmit/receive unit (WTRU), user equipment, mobile station, fixed or mobile subscriber unit, pager, or any other type of device capable of operating in a wireless environment. When referred to hereafter, an access point (AP) includes but is not limited to a base station (BS), Node-B, site controller, node, mesh point, or any other type of interfacing device in a wireless environment.

The IEEE 802.11e Quality of Service (QoS) amendment defines new Medium Access Control (MAC) procedures to support QoS requirements in 802.11 WLANs and also introduces the Hybrid Coordination Function (HCF) to provide the QoS support that was lacking in earlier 802.11 legacy systems. Two medium access mechanisms are handled by the HCF: Enhanced Distributed Channel Access (EDCA) and HCF Controlled Channel Access (HCCA). EDCA provides contention-based channel access while HCCA provides controlled channel access. The intent of HCCA is to increase efficiency by reducing the contention on the medium.

The HCCA mechanism uses a QoS-aware centralized coordinator called a hybrid coordinator (HC). The HC is collocated with a QoS Access Point (QAP) and uses the HC's higher priority of access to the wireless medium to initiate frame exchange sequences and to allocate transmission opportunities (TXOPs) to itself and other QoS Stations (QSTAs). This mechanism provides limited duration controlled access for contention-free transfer of data.

The HC has privileged access to the medium because it can initiate a transmission after a shorter waiting time than the shortest backoff delay of any station using EDCA. Under control of the HC, a nearly continuous sequence of frame exchanges can be maintained, with short, fixed delays between frames.

A non-AP QSTA, based on its requirements, requests the HC for TXOPs—both for its own transmissions as well as for transmissions from the QAP to itself. The HC either accepts or rejects the request based on admission control policy. If the request is accepted, the HC schedules TXOPs for both the QAP and the non-AP QSTA.
For transmissions from the non-AP QSTA, the HC polls the non-AP QSTA based on the parameters supplied by the non-AP QSTA at the time of its request. A QSTA may initiate multiple frame exchange sequences during a polled TXOP of sufficient duration.
For transmission to the non-AP QSTA, the QAP directly obtains TXOPs from the collocated HC and delivers the queued frames to the non-AP QSTA, again based on the parameters previously supplied by the non-AP QSTA.

The HC traffic delivery and TXOP allocation may be scheduled to meet the QoS requirements of particular traffic streams. TXOP allocations and contention-free transfers of QoS traffic can be based on the HC's knowledge of the amount of pending traffic within the QAP and its associated QSTAs.

In a VLAN mesh network, contention-based channel access can result in collisions, even among members of the same WLAN mesh network. Such collisions can degrade the QoS perceived by end users (STAs) when utilizing the mesh.

Current proposals submitted to the IEEE 802.11s task group for standardization of wireless local area network (WLAN) mesh networks only describe distributed solutions for providing contention-free access. Currently, the IEEE 802.11s proposals do not preclude extensions for vendor-specific solutions such as centralized channel access protocols.

### SUMMARY

This invention describes an IEEE 802.11e HCCA-based mechanism adapted for use by mesh points (MPs) wherein a centralized coordination function resides in MPs designated as “master” MPs. In this approach, certain MPs can assume a master role, while other MPs assume a slave role to the master. A collection of a master and its associated slaves is called a cluster. Master-slave roles are negotiated between neighbor MPs and may be based, for example, on MP capabilities, level of connectivity, etc.

IEEE 802.11e HCCA provides for coordinated channel access between one access point and multiple client stations in a WLAN. The invention described herein uses an HCCA-based channel access mechanism for coordination between multiple mesh points (MPs) in a WLAN mesh network, thereby providing a centrally coordinated contention-free medium access among members of a WLAN mesh network.

For coordinating channel access between clusters, two methods are also described:
1. A “hierarchical” structure where one level of clusters is “centrally” controlled by a higher-level master.
2. A “peer-to-peer” structure where all masters are treated as equals and utilize a “distributed” mechanism such as IEEE 802.11e EDCA for channel access between clusters.

### BRIEF DESCRIPTION OF THE DRAWING(S)

A detailed description of the invention will be set forth below in conjunction with the accompanying drawings, wherein like elements are identified by like indicia, and, wherein:

FIG. 1 shows a block diagram of the present invention according to a hierarchal mastership.

FIG. 2 shows a block diagram of the present invention according to a peer-to-peer mastership.

### DETAILED DESCRIPTION OF THE PREFERRED EMBODIMENT(S)

The IEEE 802.11e HCCA provides for coordinated channel access between one QAP and multiple non-AP QSTAs. This invention extends the use of an HCCA-based channel access mechanism for coordination between multiple mesh points (MPs) in a WLAN mesh network.

The embodiment of the WLAN mesh network described by this invention uses a master-slave architecture in which the master mesh point (MP) coordinates channel access between itself and its associated slave MPs. In this approach, certain MPs can assume a master role, while other MPs assume a slave role to the master. The collection of a master and its associated slaves is referred to herein as a cluster.

Channel access is coordinated between the master and its slaves using IEEE 802.11e HCCA-based mechanisms in which the role of the QAP is assumed by the master MP, and the role of the non-AP QSTA is assumed by the slave MPs. The HCCA-based coordination function resides in the master MP. The embodiments herein may be used with any mesh-related standards and specifically IEEE 802.11s.

For coordinating channel access between clusters, the following two methods are provided.

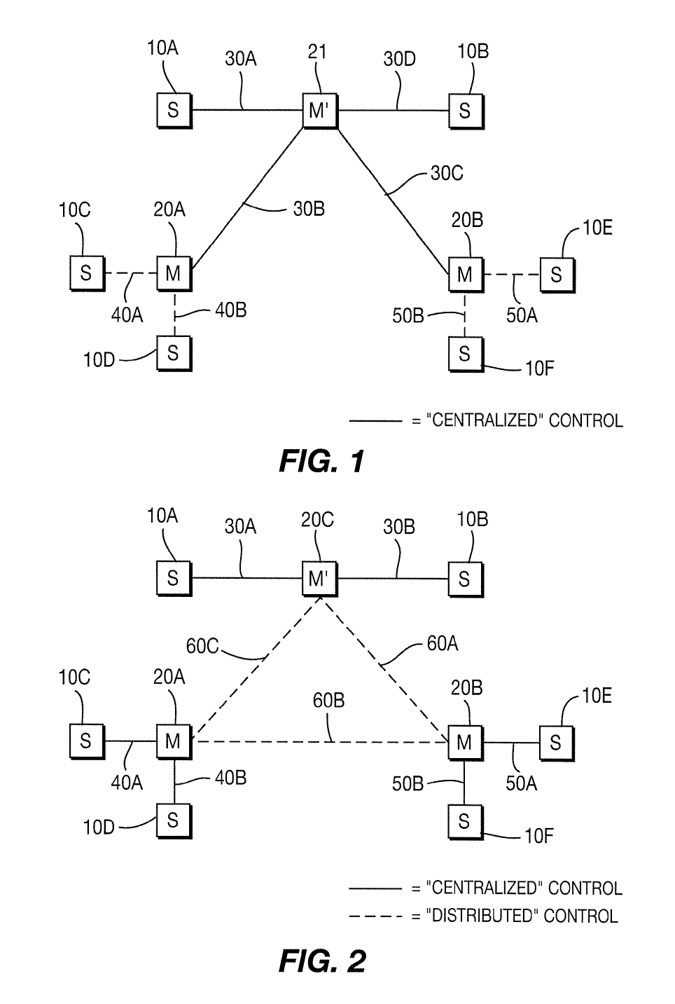

The first method employs a hierarchical structure where one level of clusters is centrally controlled by a higher-level cluster master. A two-tier example is depicted in FIG. 1, where M′ denotes the higher level master, M denotes the subservient masters, and S denotes the slaves.

FIG. 1 shows three (3) clusters. The two (2) lower level clusters each have a master M 20A supporting slaves S 10C and S 10D through paths 40A, 40B, master M 20B supporting slaves S 10E and S 10F through paths 50A, 50B and upper-level master M′ 21 supporting slaves 10A and 10B through central paths 30A, 30B, as well as lower level masters M 20A and M 20B through central control paths 30B, 30C. It should be understood that the number of slaves served by the upper level master and lower level masters and the number of lower level masters served by the upper level master may be greater in number than is shown in FIG. 1, the limited number of masters and slaves shown being chosen for purposes of simplicity. As was described above, a variety of diverse negotiations and criteria employed in such negotiations may be employed to select master and slave MPs.

For example, channel access of slave S 10E in one of the two subservient clusters in FIG. 1 is conveyed to its (lower level) master M 20B. Master M′ 21, having been designated as a higher-level cluster master, lower-level cluster master M 20B conveys the access request from slave S 10E to higher-level master 21, which hierarchical structure eliminates contention between and among the three (3) clusters shown in FIG. 1. Higher level master M′ 21 supports slaves S 10A and S 10B, as well as the lower-level masters M 20A and M 20B thereby providing the coordination function for the lower-level clusters as well as its own cluster. Although, FIG. 1, shows a two-tiered hierarchical structure, it should be understood that a multi-tiered hierarchical structure greater than two (2) may be employed as long as the upper-most level master is directly connected to the subservient masters on the level just below the upper-most master.

The second method employs a peer-to-peer structure where all masters are treated as equals and utilize a distributed mechanism such as IEEE 802.11e EDCA for channel access between masters. This is depicted in FIG. 2, where M 20A, M 20B and M 20C denote the masters coupled in a distributed manner by distributed control paths 60A-60C, and S 10A through S 10F denote the slaves, coupled to respective ones of the masters by centralized control paths 30A through 50B.

In this peer-to-peer” structure, master/slave/peer roles are negotiated between neighbor MPs and may be based, for example, on MP capabilities or level of connectivity. The method of master/slave/peer role negotiation is not addressed by this invention. Assuming a request for access is conveyed to master M 20B by slave S 10E, access is prioritized according to the above-mentioned, as well as, other appropriate criteria. Although, FIG. 2 shows an example in which three (3) masters of three (3) clusters negotiate, it should be understood that a greater or lesser number of such clusters may be arranged in a peer-to-peer mastership.

With respect to this disclosure, coordination applies to devices (client STAs, APs, MPs, MAPs) that are using the services of the same WLAN mesh network.

It should be noted that the channel access, as described herein, is per channel specific. For example, in a case of multi-radio/multi-channel nodes, the HCCA mechanism can be used for the access on one channel (for instance to control one channel common to the Master and all its slaves), whereas another access mechanism (e.g., DCA, EDCA) can be used on the other channels.

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. In a wireless local area network (WLAN) mesh network of clusters, each cluster having a master node with a plurality of associated slave nodes, a method for coordinating channel access between the clusters, comprising:
establishing a structure of clusters as a hierarchal mastership, wherein a higher level master node serves a plurality of subservient master nodes; and
centrally controlling the hierarchal mastership by the high level master node using an HCF controlled channel access (HCCA) mechanism.

2. The method of claim 1, wherein the higher level master node is configured as a QoS access point (QAP), and the plurality of associated slave nodes are configured as a plurality of QoS stations (QSTAs).

3. The method of claim 1, wherein the HCCA mechanism comprises a QoS-aware centralized hybrid coordinator (HC), said HC:
initiating frame exchange sequences.

4. The method of claim 3, said HC:
allocating transmission opportunities to the slave nodes.

5. The method of claim 4, said HC:
maintaining a nearly continuous sequence of frame exchanges between nodes with short fixed delays between frames.

6. The method of claim 2, a QSTA:
requesting transmission opportunities based on its requirements, for its own transmissions to the QAP and for transmissions from the QAP to the QSTA, wherein a plurality of parameters are supplied to the HC for coordinating channel access.

7. The method of claim 6, the HC:
accepting the request of the QSTA based on an admission control policy; and
scheduling transmission opportunities for both the QAP and the QSTA.

8. The method of claim 6, the HC:
rejecting a request of the QSTA based on an admission control policy.

9. The method of claim 2, the HC:
polling transmissions from the QSTA; and
exchanging multiple frame sequences during a polled transmission opportunity.

10. The method of claim 2, the QAP:
obtaining transmission opportunities directly from the HC; and
delivering multiple frames to the QSTA, based on parameters previously supplied by a non-AP QSTA.

11. The method of claim 2, the HC:
controlling frame exchange sequences and transmission opportunity allocations based on QoS requirements of particular traffic streams.

12. The method of claim 2, the HC:
controlling frame exchange sequences and transmission opportunity allocations based on pending traffic within the QAP and associated QSTAs.

13. The method of claim 1 wherein the hierarchal mastership is configured as a two-tiered hierarchy having lower level masters subservient to a higher level master.

14. The method of claim 1 wherein the hierarchal mastership is configured as a multi-tiered hierarchy having lower level masters configured to be subservient to at least one middle level master and the at least one middle level master configured to be subservient to the higher level master.

15. In a wireless local area network (WLAN) mesh network of clusters, each cluster having a master node with a plurality of associated slave nodes, a method for coordinating channel access between the clusters, comprising:
establishing a structure of clusters in a peer-to-peer mastership, wherein all master nodes are treated as equals; and
controlling the peer-to-peer mastership by a distributed mechanism.

16. The method of claim 15, wherein the distributed mechanism is in accordance with IEEE 802.11e enhanced distributed channel access (EDCA).

17. The method of claim 15, wherein the distributed mechanism is in accordance with IEEE 802.11e distributed channel access (DCA).

18. The method of claim 15, wherein master to slave and peer to peer roles are negotiated between neighbor nodes.

19. The method of claim 18, wherein role negotiation is based on node capabilities.

20. The method of claim 18, wherein role negotiation is based on level of connectivity.

21. The method of claim 15, wherein the mesh network has multi-channel nodes, and the mechanism for controlling the mastership is per channel specific.

22. The method of claim 21, an HCCA mechanism:
controlling channel access of one channel common to a cluster; and
an EDCA mechanism:
controlling channel access of another channel common to another cluster.

23. The method of claim 21, an HCCA mechanism:
controlling channel access of one channel common to a cluster; and
a DCA mechanism:
controlling channel access of another channel common to another cluster.

24. A wireless local area network (WLAN), comprising:
a mesh network of clusters, each cluster comprising:
a master node and a plurality of associated slave nodes, said clusters, in order to coordinate channel access between the clusters, being configured to provide a hierarchal mastership, wherein a higher level master node is configured to serve a plurality of subservient master nodes of a plurality of lower level clusters; and
the higher level master node having an HCF controlled channel access (HCCA) mechanism for centrally controlling the clusters in the hierarchal mastership.

25. The WLAN of claim 24, wherein at least the higher level master node is configured as a mesh point.

26. The WLAN of claim 24, wherein at least the higher level master node is configured as an access point (AP).

27. The WLAN of claim 24, wherein the slave nodes are configured as STAs.

28. The WLAN of claim 24, wherein the slave nodes are configured as WTRUs.

29. The WLAN of claim 26, wherein the AP is configured as a base station (BS).

30. The WLAN of claim 24, wherein the higher level master node is configured as a QoS access point (QAP), and the plurality of associated slave nodes are configured as a plurality of QoS stations (QSTAs).

31. The WLAN of claim 24, wherein the HCCA mechanism comprises a QoS-aware centralized hybrid coordinator (HC) for initiating frame exchange sequences.

32. A wireless local area network (WLAN), comprising:
a mesh network of clusters, each cluster comprising a master node and a plurality of associated slave nodes, whereby coordinating channel access between the clusters, comprises:
said clusters being arranged in a peer-to-peer mastership, wherein all master nodes are configured as equals; and
a distributed mechanism controls the peer-to-peer mastership.

33. The WLAN of claim 32, the distributed mechanism being configured to provide enhanced distributed channel access (EDCA) in accordance with IEEE 802.11e.

34. The WLAN of claim 32, the distributed mechanism being configured to provide distributed channel access (DCA) in accordance with IEEE 802.11e.
